(19) United States
(12) Patent Application Publication
(10) Pub. No.: US 2015/0084503 A1
(43) Pub. Date: Mar. 26, 2015

(54) Pluggable Control Module For LED Lighting Device

(71) Applicant: Lightel Technologies, Inc., Renton, WA (US)

(72) Inventors: Wei Liu, Shenzhen (CN); Chia-Yiu Maa, Bellevue, WA (US); Pai-Sheng Shen, Bellevue, WA (US)

(73) Assignee: Lightel Technologies, Inc., Renton, WA (US)

(21) Appl. No.: 14/146,535

(22) Filed: Jan. 2, 2014

(30) Foreign Application Priority Data
Sep. 25, 2013 (CN) 201310440236.2

(51) Int. Cl. F21V 23/06; F21V 23/04; F21V 23/00

(52) U.S. Cl. CPC F21V 23/06; F21V 23/006; F21V 23/0435; F21V 23/0471; F21V 23/0442; F21V 23/0464
USPC 315/51

(57) ABSTRACT

Embodiments of a plug-and-play control module for a LED lighting device are described. In one aspect, a plug-and-play control module for a LED lighting device includes a main body and a control module socket. The control module socket includes an AC socket and a DC socket. The main body includes a housing, a control unit, an input port and an output port. The control unit resides inside the housing. A portion of the input port and a portion of the output port protrude outside the housing and connect to the control module socket. The control unit controls an output current flowing through the output socket and thus the on/off of the LED lighting device.

### CROSS REFERENCE TO RELATED PATENT APPLICATION

The present disclosure claims the priority benefit of Patent Application No. 201310440236.2 filed on Sep. 25, 2013 with the State Intellectual Property Office of China.

### BACKGROUND

1. Technical Field

The present disclosure relates to the field of luminaires and, more particularly, to a pluggable control module for light-emitting diode (LED) lighting device.

2. Description of the Related Art

The lifetime of a traditional fluorescent tube is around 5000 hours and the ballast used to energize the tube has a lifetime of around 20,000 to 30,000 hours, as compared the lifetime of a lighting fixture which is over 100,000 hours. Due to the limitation posed by the shorter lifetime of fluorescent tubes, the design goal of linear lighting fixtures has been to use a standardized connection interface, such as the G13 socket, that facilitates the installation and uninstallation of the fluorescent tube into and out of the fixture, with all installation able to be safely performed by any consumer without any tools. Also, since the lifetime of the ballast is longer than that of the fluorescent tube, the ballast is normally screwed onto the fixture and must be changed by a qualified electrician, as ballast replacement involves re-wiring the power line.

The relatively recent appearance of the LED tube on the market as a replacement for the fluorescent tube has challenged the validity of the original design principal for linear fixtures. This is due to the fact that an LED tube has a potential lifetime exceeding 100,000 hours, and therefore does not require replacement within the lifetime of the linear fixture. As such, there is no longer the need for easy and frequent tube replacement, and thus the use of the standard G13 based socket interface becomes meaningless. Moreover, although the majority of LED tubes on the market still support the G13 based socket as a direct replacement for G13 based fluorescent tubes, the new linear LED luminaire, which consists of both the linear fixture and LED tube, does not require the G13 socket interface.

At the same time, while an LED chip has a potential lifetime of over 100,000 hours, the average lifetime of an LED driver is around 20,000 to 30,000 hours, which limits the overall lifetime of the LED lamp. The same lifetime limitation exists in the electronic components used in the LED light control module. This limitation gives rise to a new problem unique to the LED luminaire; namely, the LED light source or lamp has a significantly longer lifetime than the driver and the control module. Thus, the new design need of LED fixtures is the easy replacement of the driver or control module, rather than the LED tube or light source. Presently, all of the linear fixtures on the market hide the driver, the ballast, or the control module inside the fixture, making them difficult to access. As a result, any part replacement requires a qualified electrician. The traditional linear fixture design is clearly outdated with respect to the LED light source and driver.

### SUMMARY

In one aspect, a plug-and-play control module for a LED lighting device may include a main body and a control module socket. The control module socket may include an AC socket and a DC socket. The main body may include a housing, a control unit, an input port and an output port. The control unit may reside inside the housing. A portion of the input port and a portion of the output port may protrude outside the housing and connect to the control module socket. The AC socket may connect to the input port to receive electricity form an external power supply. The control unit may be configured to transmit the electricity via the output port to the DC socket. The control unit may be configured to activate the output port to transmit a DC current responsive to the control unit receiving a first signal. The control unit may be further configured to deactivate the output port responsive to the control unit receiving a second signal.

In some embodiments, the main body may further include a driver for the LED lighting device. An input port of the driver may connect to the input port of the control module. An output port of the driver may connect to the output port of the control module.

In some embodiments, the AC socket and the DC socket may be hole-shaped ockets. The input port and the output port may be cylindrical pins. The cylindrical pins may be inserted into the hole-shaped sockets. In some embodiments, the hole-shaped sockets and the cylindrical pins may be aligned in a row.

In some embodiments, the AC socket and the DC socket may be metal plates. The input port and the output port may be elastic metal plates. The metal plates and the elastic metal plates may be connected when the main body is connected to the control module socket. In some embodiments, the control module may further include a locking mechanism configured to fasten the main body and the control module socket together.

In some embodiments, the control unit may further include a control signal receiver configured to receive control signals that include at least an on-off signal, a dimming signal, and a color tuning signal.

In some embodiments, the control signal receiver may include an Internet network interface configured to receive control signals according to one or more IP protocols.

Alternatively, the control signal receiver may be configured to receive the control signals through infra-red signals, WiFi signals, Bluetooth signals, power-line-transmitted signals, a control signal line, or a combination thereof. Additionally, the control signal receiver may include an Internet network interface configured to receive control signals according to one or more IP protocols.

In some embodiments, the control unit may further include a motion sensor configured to activate the output port responsive to detection of a motion.

In some embodiments, the control unit may further include a sound sensor configured to activate the output port responsive to detection of a sound.

In some embodiments, the control unit may further include a dimmer disposed between the input port and the driver and configured to adjust at least a light output level or a color temperature of the LED lighting device. Additionally, the control unit may further include an ambient light sensor disposed between the input port and the dimmer and configured to control the dimmer automatically according to an ambient light level.

In some embodiments, the control unit may further include a dimmer disposed between the output port and the driver and configured to adjust at least a light output level or a color temperature of the LED lighting device. Additionally, the control unit may further include an ambient light sensor disposed between the output port and the driver and configured to control the dimmer automatically according to an ambient light level.

The claims and advantages will be more readily appreciated as the inventive concept becomes better understood by reference to the following detailed description and the accompanying drawings showing exemplary embodiments, in which like reference symbols designate like parts. For clarity, various parts of the embodiments in the drawings are not drawn to scale.

### BRIEF DESCRIPTION OF THE DRAWINGS

The accompanying drawings are included to aid further understanding of the present disclosure, and are incorporated in and constitute a part of the present disclosure. The drawings illustrate a select number of embodiments of the present disclosure and, together with the detailed description below, serve to explain the principles of the present disclosure. It is appreciable that the drawings are not necessarily in scale as some components may be shown to be out of proportion than the size in actual implementation in order to clearly illustrate the concept of the present disclosure.

FIG. 1 schematically depicts an embodiment of the present invention.

FIG. 2 schematically depicts the first embodiment of the present invention from another angle.

FIG. 3 schematically depicts the application of the first embodiment of the present invention.

FIG. 4 schematically depicts another embodiment of the present invention.

FIG. 5 schematically depicts the second embodiment of the present invention from another angle.

FIG. 6 schematically depicts the application of the second embodiment of the present invention.

### DETAILED DESCRIPTION OF PREFERRED EMBODIMENTS

### Overview

Various implementations of the present invention and related inventive concepts are described below. It should be acknowledged, however, that the present invention is not limited to any particular manner of implementation, and that the various embodiments discussed explicitly herein are primarily for purposes of illustration. For example, the various concepts discussed herein may be suitably implemented in a variety of LED lighting devices having different form factors.

The present invention discloses a plug-and-play control module for the LED luminaire that eliminates the limitations of the traditional linear fixture and supports replacement of the control module able to be performed by any end user.

The control unit of the present invention supports a plug-and-play interface that allows the replacement and upgrade of the control unit to be safely performed without any tools by any end user, thus eliminating the need for an electrician.

Additionally, a new plug-and-play control module could add new functionality to the LED luminaire. For example, the old control module may not have dimming capability. By replacing the old control module with a new control module with dimming capability, the LED luminaire would become dimmable without any modification to the rest of the LED luminaire. Similarly, a new plug-and-play control module with an ambient light sensor would allow for automatic light adjustment of the LED lighting device without any modification to the rest of the LED luminaire.

Separately, a new plug-and-play control module may be used to upgrade existing functionality. For example, an older control module with a motion sensor that only has a detection range of 2 meters could be upgraded to a new control module with a better motion sensor that increases the detection range to 10 meters. In the same way, an older control module that uses an infra-red remote control that is limited to distances of up to 5 meters and cannot penetrate through a solid object may be replaced with a new control module using WiFi remote control that is effective over distances of up to 20 meters and can penetrate solid objects. Another example would be to use a new control module with a high-performance driver to achieve higher energy efficiency. An end user would be able to enjoy these upgrade functionalities without making any modification to the rest of the LED luminaire.

Different plug-and-play control modules would also allow for product differentiation. For examples, an IR-based plug-and-play control module would be available for users or areas that require IR remote control, while a WiFi-based plug-and-play control module would be available for users or areas that require WiFi-based remote control. In both cases, the rest of the LED luminaire would be kept exactly the same, reducing production and inventory costs while offering end users more choices and an LED luminaire with increased functionality.

### Example Implementations

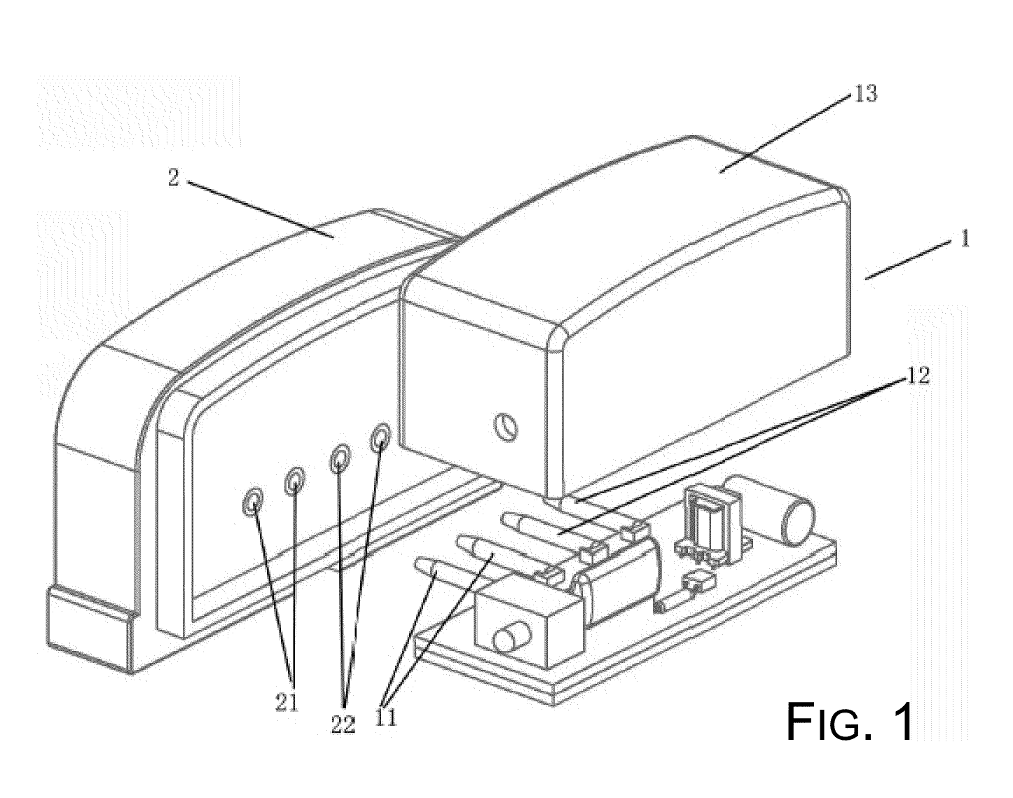

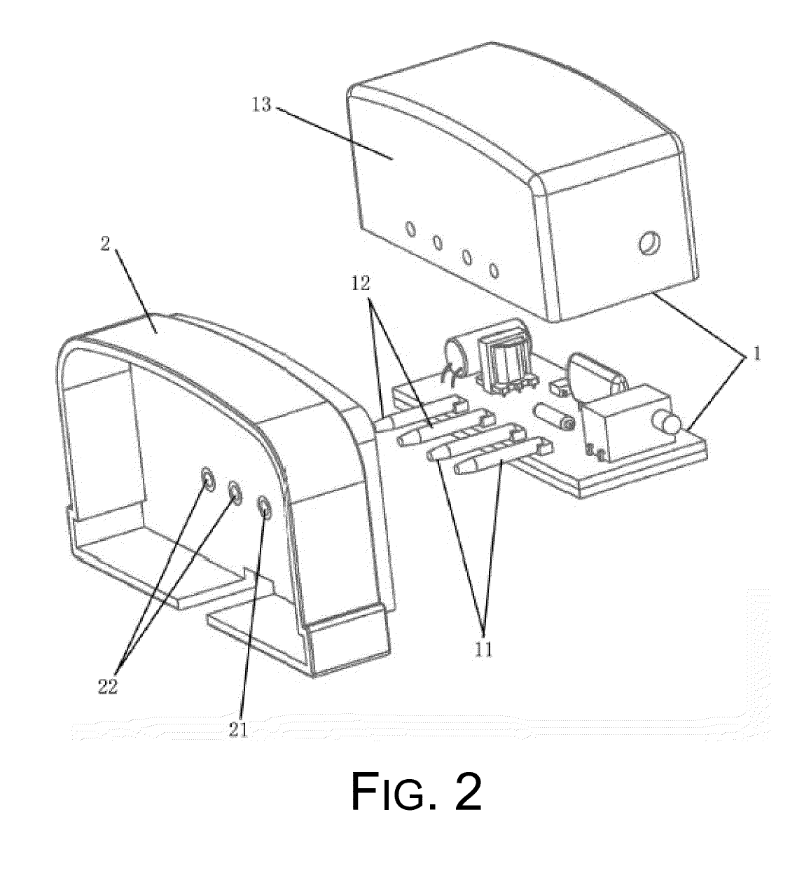

FIGS. 1 and 2 illustrates one non-limiting embodiment of the plug-and-play control module of the present invention. The plug-and-play control module comprises a main body 1 and a control module socket 2, wherein the control module socket 2 includes AC sockets 21 and DC sockets 22, with all sockets aligned in one row; the main body 1 includes a housing 13 made of insulating material, a driver for supplying the DC power, a control unit, an input port 11 and output port 12 consisting of cylindrical pins aligned in a row to match the sockets; the driver and the control unit reside inside the housing 13; part of the input port 11 and part of the output port 12 reside outside of the housing 13 and connect to the control module socket 2; the AC socket 21 connects to the input port 11 to receive external electricity; the control unit and the driver transmit the electricity via the output port 12 to the DC socket 22; the control unit includes the control signal receiver that receives external control signals for turning the LED luminaire on/off and for controlling the light output level and color temperature of the LED luminaire.

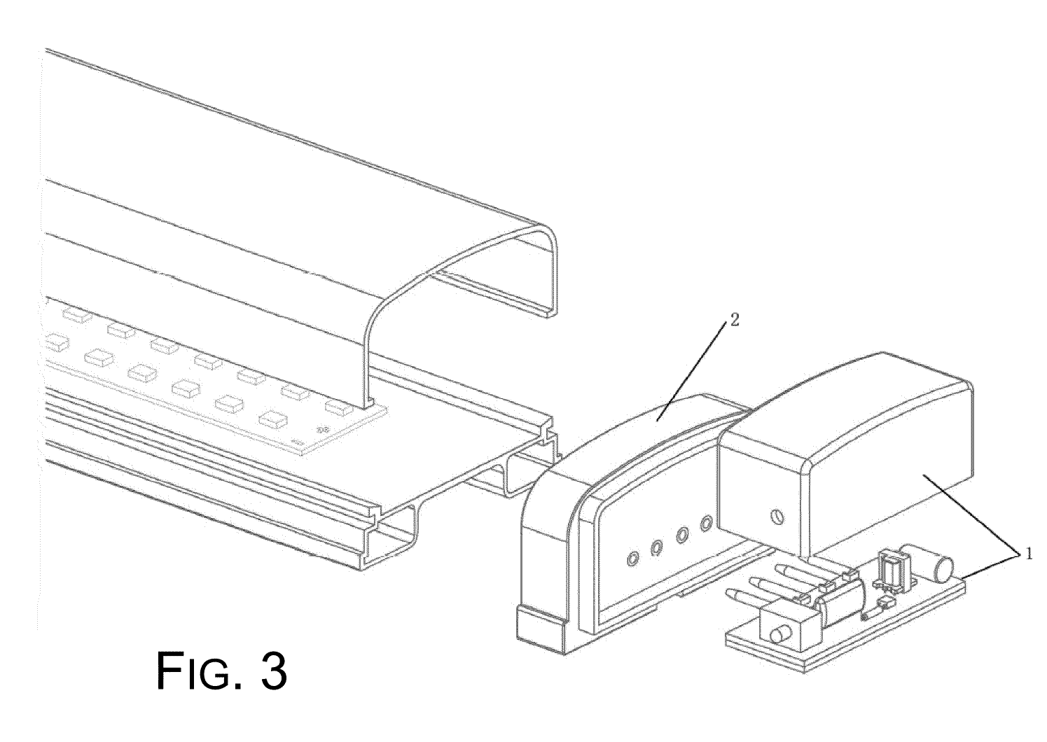

When the control signal receiver receives an “ON” signal, the control unit activates the output port 12 to transmit the DC current; the control signal receiver receives an “OFF” signal, the control unit deactivates the output port 12. The control signal receiver may be an infra-red receiver, a WiFi receiver, a Bluetooth receiver, a power-line-transmitted signal receiver, or a receiver controlled via a control signal line. The control signal receiver may also incorporate an Internet network interface, capable of receiving control signals according to IP protocol. FIG. 3 illustrates the application of the first example embodiment of the present invention, wherein the plug-and-play control module is fastened onto one side of the LED luminaire with the control module socket 2.

In other embodiments of the present invention, the control signal receiver includes a motion sensor, sound sensor, ambient light sensor, and the combination thereof. Alternatively, the control unit may include a motion sensor, sound sensor, ambient light sensor, or the combination thereof. The motion sensor delivers an “ON” signal when motion is detected. The sound sensor delivers an “ON” signal when sound is detected. The ambient light sensor delivers an “ON” signal when the ambient light level drops below a preset threshold.

In other embodiments of the present invention, the control unit includes a dimmer that is located between the input port and the driver and adjusts the light output level of the LED luminaire. The standard TRIAC-based dimmer may be used. In other embodiments, an ambient light sensor is inserted between the input port and the dimmer and enables the dimmer to automatically adjust the light output level of the LED luminaire according to the ambient light level. The higher the ambient light level, the lower the light output level of the LED luminaire. The lower the ambient light level, the higher the light output level of the LED luminaire. In other embodiments, the control unit includes a color tuner for adjusting the color temperature of the LED luminaire. The color tuner may also be used together with a dimmer to simultaneously control both the color temperature and the light output level of the LED luminaire.

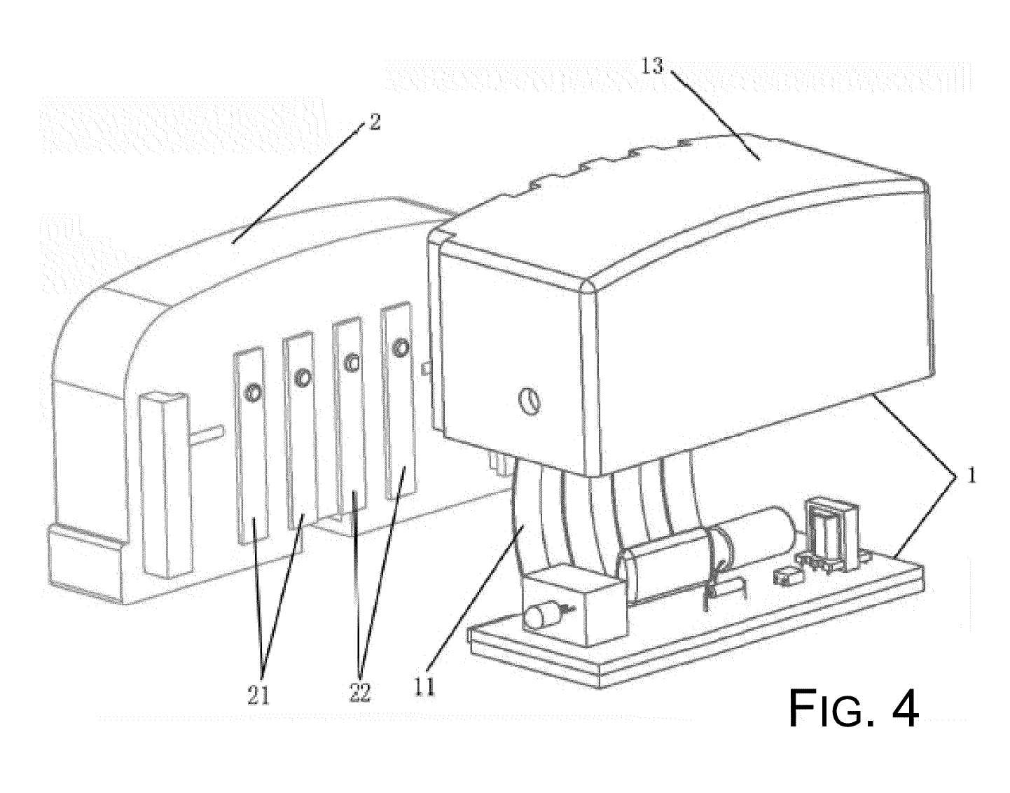

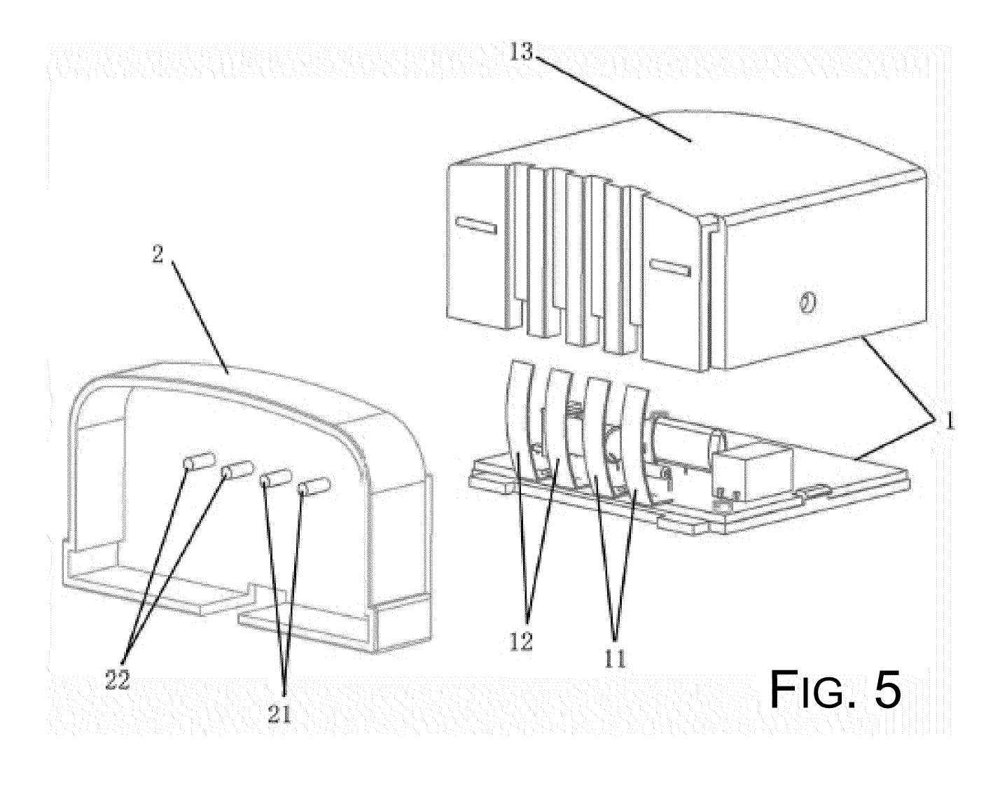

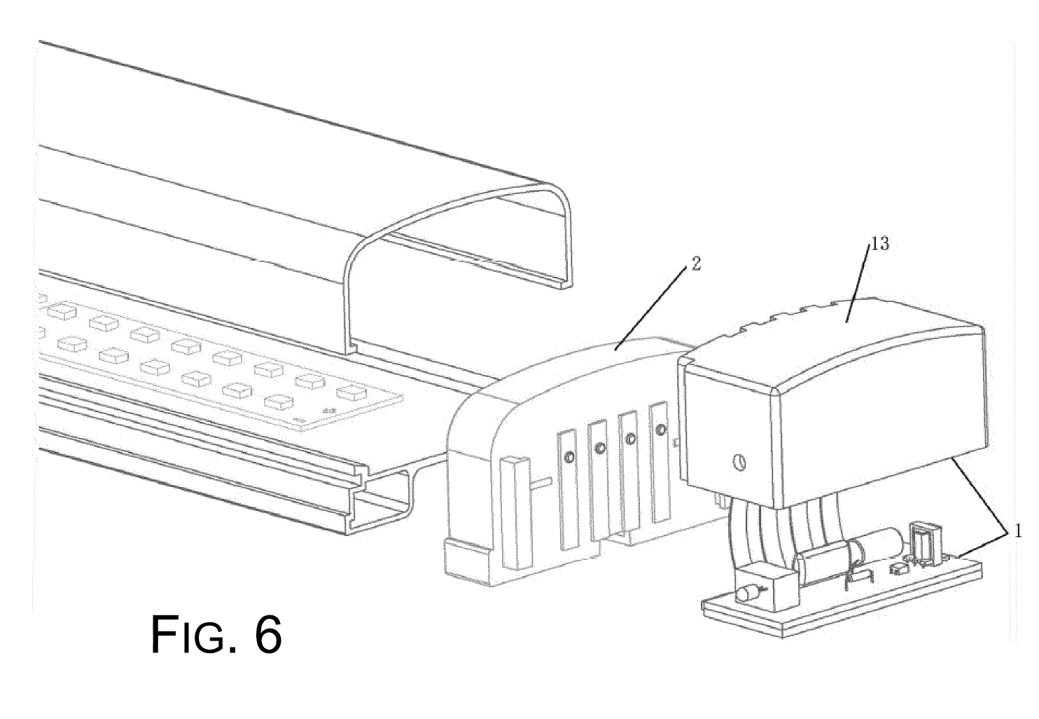

FIGS. 4 and 5 illustrate another embodiment of the present invention. In this embodiment, the AC socket 21 and the DC socket 22 consist of a metal plate, the input port 11 and the output port 12 consist of an elastic metal plate, and a locking mechanism resides between the main body 1 and the control module socket 2. The rest of this embodiment is the same as the first embodiment mentioned above and therefore will not be repeated here. The main body 1 is installed onto the control module socket 2 from above, along the guiding groove of the locking mechanism. The locking mechanism ensures that the main body 1 is fastened onto the control module socket 2 and thus the sockets 21, 22 are tightly connected to the ports 11, 12. FIG. 6 illustrates the application of the second example embodiment of the present invention, wherein the plug-and-play control module is fastened onto one side of the LED luminaire with the control module socket 2.

During normal operation, the plug-and-play control module is fastened onto one side of the LED luminaire, as shown in the example mentioned above. If the driver or any component inside the control module stops functioning, an end user can easily and safely unplug the control module from the LED luminaire and replace it with a new control module. Moreover, when a control module upgrade, such as a more energy efficient driver, a more accurate dimmer, a better ambient light sensor, a higher quality wireless receiver, a more powerful color tuner, or a more programmable control unit, becomes available, an end user can perform the upgrade by simply changing out the old control module with the new one. The present invention greatly simplifies the maintenance and upgrade of the control module of the LED luminaire.

### Additional and Alternative Implementaion Notes

Although the techniques have been described in language specific to certain applications, it is to be understood that the appended claims are not necessarily limited to the specific features or applications described herein. Rather, the specific features and examples are disclosed as non-limiting exemplary forms of implementing such techniques.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

For the purposes of this disclosure and the claims that follow, the terms “coupled” and “connected” may have been used to describe how various elements interface. Such described interfacing of various elements may be either direct or indirect.

What is claimed is:

1. A plug-and-play control module for a LED lighting device, comprising:
a main body; and
a control module socket,
wherein:
the control module socket comprises an AC socket and a DC socket;
the main body comprises a housing, a control unit, an input port, and an output port;
the control unit resides inside the housing;
a portion of the input port and a portion of the output port protrude outside the housing and connect to the control module socket;
the AC socket connects to the input port to receive electricity form an external power supply;
the control unit is configured to transmit the electricity via the output port to the DC socket;
the control unit is configured to activate the output port to transmit a DC current responsive to the control unit receiving a first signal; and
the control unit is further configured to deactivate the output port responsive to the control unit receiving a second signal.

2. The control module of claim 1, wherein the main body further comprises a driver for the LED lighting device, wherein an input port of the driver connects to the input port of the control module, and wherein an output port of the driver connects to the output port of the control module.

3. The control module of claim 1, wherein the AC socket and the DC socket are hole-shaped sockets, wherein the input port and the output port are cylindrical pins, and wherein the cylindrical pins are inserted into the hole-shaped sockets.

4. The control module of claim 3, wherein the hole-shaped sockets and the cylindrical pins are aligned in a row.

5. The control module of claim 1, wherein the AC socket and the DC socket are metal plates, wherein the input port and the output port are elastic metal plates, and wherein the metal plates and the elastic metal plates are connected when the main body is connected to the control module socket.

6. The control module of claim 5, further comprising a locking mechanism configured to fasten the main body and the control module socket together.

7. The control module of claim 1, wherein the control unit further comprises a control signal receiver configured to receive control signals comprising at least an on-off signal, a dimming signal, and a color tuning signal.

8. The control module of claim 1, wherein the control signal receiver is configured to receive the control signals through infra-red signals, WiFi signals, Bluetooth signals, power-line-transmitted signals, a control signal line, or a combination thereof.

9. The control module of claim 8, wherein the control signal receiver includes an Internet network interface configured to receive control signals according to one or more IP protocols.

10. The control module of claim 1, wherein the control unit further comprises a motion sensor configured to activate the output port responsive to detection of a motion.

11. The control module of claim 1, wherein the control unit further comprises a sound sensor configured to activate the output port responsive to detection of a sound.

12. The control module of claim 2, wherein the control unit further comprises a dimmer disposed between the input port and the driver and configured to adjust at least a light output level or a color temperature of the LED lighting device.

13. The control module of claim 12, wherein the control unit further comprises an ambient light sensor disposed between the input port and the dimmer and configured to control the dimmer automatically according to an ambient light level.

14. The control module of claim 2, wherein the control unit further comprises a dimmer disposed between the output port and the driver and configured to adjust at least a light output level or a color temperature of the LED lighting device.

15. The control module of claim 14, wherein the control unit further comprises an ambient light sensor disposed between the output port and the driver and configured to control the dimmer automatically according to an ambient light level.
